(19) United States
(12) Patent Application Publication
(10) Pub. No.: US 2006/0243746 A1
(43) Pub. Date: Nov. 2, 2006

(54) Pressurized fluid dispenser

(75) Inventors: Michael D. Osborne, Asheville, NC (US); Richard M. Nallenweg, Weaverville, NC (US)

Correspondence Address: ARTHUR J. PLANTAMURA;GENERAL CHEMICAL PERFORMANCE PRODUCTS LLC., 90 EAST HALSEY ROAD, PARSIPPANY, NJ, 07054, US

(73) Assignee: Balcrank Products, Inc.

(21) Appl. No.: 11/477,309

(22) Filed: Jun. 29, 2006

Related U.S. Application Data
(63) Continuation-in-part of application No. 10/377,433, filed on Feb. 28, 2003, now Pat. No. 6,986,270.

(51) Int. Cl. B67D 5/58

(52) U.S. Cl. 222/189.1

(57) ABSTRACT

A readily portable self-contained, pre-pressurized lubricating fluid dispenser is provided. The tank contains an internal impermeable flexible membrane that isolates the working fluid to be dispensed from the pressurizing delivery fluid, e.g., compressed air, which dispenses the servicing fluid under pressure. The dispenser that can be readily pre-loaded with deliverable servicing fluid, such as motor vehicle lubricant. The tank supplied with or without the servicing fluid is provided with pre-pressurized gas as a permanent sealed fixture with the tank to provide a fully self-contained portable servicing tool. The working fluid is readily replenishable when exhausted. The flexible membrane isolates the working replenishable servicing fluid from the pressurized gas. The unit may be secured to a wall or mobile attachment to a convenient location for periodic scheduled servicing and may comprise a wheeled supporting carriage or a back-pack configuration for optimum versatility. The pressurized permanently contained-in-a-sealed-compartment pressurized gas is ample to dispense a full compartment of working fluid and no additional pressure or auxiliary means is required to dispense the entirety of the servicing fluid carried in the tank. The unit is readily replenishable with servicing fluid.

This is a Continuation-in-Part of application Ser. No. 10/337,433 filed Jan. 2, 2003.

The invention relates to a re-usable portable pre-pressurized lubricant dispensing tank and in particular, the invention relates to a permanently pre-pressurized portable unit that permits easy replenishment with lubricant when the lubricant supply in the tank is depleted.

### BACKGROUND OF THE INVENTION

Pressurized commercial lubricating devices typically consist of relatively cumbersome tanks with complex auxiliary equipment needed to dispense the lubricant ordinarily, in prior art arrangements pressurized air is introduced into the tank to expel the working fluid. For example, in the case of lubricating devices, the lubricant is dispensed from the tank by the effect of being pushed out by the pressurized air. Tanks of this kind may be of a mobile type that is mounted on wheels to facilitate movement of the unit to the servicing site. Units of this kind frequently are used in the industry to deliver petroleum lubrication products such as oil and/or grease commonly, for example, to lubricate machinery or to service motor vehicles.

The known, currently used lubricant dispensing tanks, primarily due to the necessity of auxiliary apparatus needed to allow the dispenser to function effectively, suffer from several disadvantages that limit application of units of this type to a wider spectrum of servicing functions. Notable among the disadvantages of the known units of this kind are the following:
1. Lack of versatility so that it is difficult to service hard to reach locations, such as, machinery accessible only by climbing a ladder.
2. Use of long dispensing hoses drawn from a fixed location which when extended present a substantial obstruction and is a tripping hazard to personnel.
3. When functioning the tank requires constant charging with pressurized air, such as a compressor, to dispense effectively.
4. The dispensing devices are devised so that air mixes with the liquid dispensed producing a frothy mixture of air and liquid. Such air/liquid mixture produces incorrect readings on the positive displacement fluid flow meters. Positive displacement flow meters will register air flow, fluid flow, or any combination of air or fluid flow and it is undesirable to register air flow when the user is trying to dispense a fixed amount of liquid. This is a concern especially when the servicing lubrication in the tank is nearly exhausted. As air begins to be dispensed, the steady stream of fluid is interrupted and the dispenser begins to stutter and spit, which can also produce undesirable splashing and spraying.
5. The compressed air to affect the dispensing pressure often contains water vapor and moisture. This water is carried into the tank, thus contaminating the lubrication fluid and introducing a source of corrosion.

### SUMMARY OF THE INVENTION

The primary objective of the invention is to provide a readily portable lubricating tank type device that is supplied with a self-contained permanently pressurized dispensing source within the tank. The tank contains a flexible internal membrane which is liquid gas impermeable and which separates the dispensing pressure from the lubricant, i.e., the membrane isolates the fluid to be dispensed from the compressed air that is used to propel and discharge the lubricant.

It is a more particular objective of the invention to provide a portable self-contained, pre-pressurized lubricant dispensing that is supplied so as to be usable without auxiliary equipment, for immediate dispensing of the lubricant, and has the capability to permit the tank to be used as a back pack. The contemplated dispenser tank is devised so that it is permanently pre-pressurized by the tank supplier and is readily replenishable with a lubricant supply when the prior charged lubricant in the tank has been dispensed to depletion.

It is a more particular and preferred objective of the invention to provide a mobile portable self-contained, permanently pre-pressurized lubricator tank, adaptable as a back pack that contains an internal liquid and gas impermeable flexible membrane that isolates the lubricant from the supply of permanently confined pressurized gas. Both of which are contained in the charged tank and wherein the gas functions as the delivery or ejection mechanism for the lubricant.

It is still a further objective of this invention to provide a readily portable type tank unit capable of being carried as a back pack, that contains an internal flexible impermeable separator membrane to provide separate chambers and thereby to isolate the pre-pressurized dispensing medium e.g., the air from the lubricant to be dispensed. The tank of the invention has the advantage of being fully operable and capable of being delivered to the working site for immediate dispensing of the servicing lubricant. The dispensing pressure medium e.g., the pressurized air, isolated from the lubricant by the flexible impermeable membrane and permanently confined in the tank, is sufficient to maintain appropriate pressure to effectively deliver the working fluid for the life of the tank. No additional air input is required to dispense the total capacity, i.e., the full quantity of the lubricant carried in the tank. The unit is equipped so that the lubricant content when depleted can be readily replenished for immediate use resumption such as, by an independently scheduled supplier or from a large refill tank, for example.

Advantages of the dispensing unit of the invention include:
1. A permanent self-contained, pre-pressurized lubricant dispensing unit for which compressed air is thereafter never needed, i.e., no hand pump, such as that used with a portable insecticide sprayer or a motorized pump is required.
2. The compressed air dispenser medium and the lubricant to be dispensed are isolated and cannot mix thereby affording accurate meter readings and moisture or water vapor contained in the compressed air cannot mix with the fluid to be dispensed, thus preventing contamination.
3. Provision of versatility, which includes a readily portable back-pack type configuration, permits access to many applications unreachable by fixed or wheeled design dispensers, such as when an operator must climb a ladder to access the machinery to be lubricated.

The invention is particularly beneficial when used with lubricants, such as, expensive synthetic oils, where water contamination adversely affects the lubrication properties of lubricating fluids of this kind and is especially useful because of the easy unencumbered portability for lubricating machinery or equipment not otherwise assessable.

### BRIEF DESCRIPTION OF THE DRAWING

FIG. 1 is a diagrammatic elevational view of a preferred embodiment of the invention illustrating the fluid dispensing tank equipped with a pressure gauge and dispensing hose with nozzle.

FIG. 2 is illustrates a diagrammatic of the interior of the tank of FIG. 1 in cross-section.

FIG. 3 is an elevational view of a modified version of the invention of FIG. 1 in which the lubricant fluid dispensing tank mounted on a wheeled dolly.

FIG. 4 is an elevation view of the lubricating tank of the invention of FIG. 1 shown equipped with a harness for back-pack utility.

### DETAILED DESCRIPTION OF THE INVENTION

For various applications there exists a need for a genuinely portable self-contained lubricant supplying mechanism which can allow the lubricant under pressure, such as, for example, to lubricate factory machinery e.g. in paper or textile mills in which maintenance is a constant obligation and wherein the equipment to be serviced is not on a ground floor. One particular wide spread and important usage of the invention is in auto dealership and servicing facilities for dispensing automobile lubricating oil.

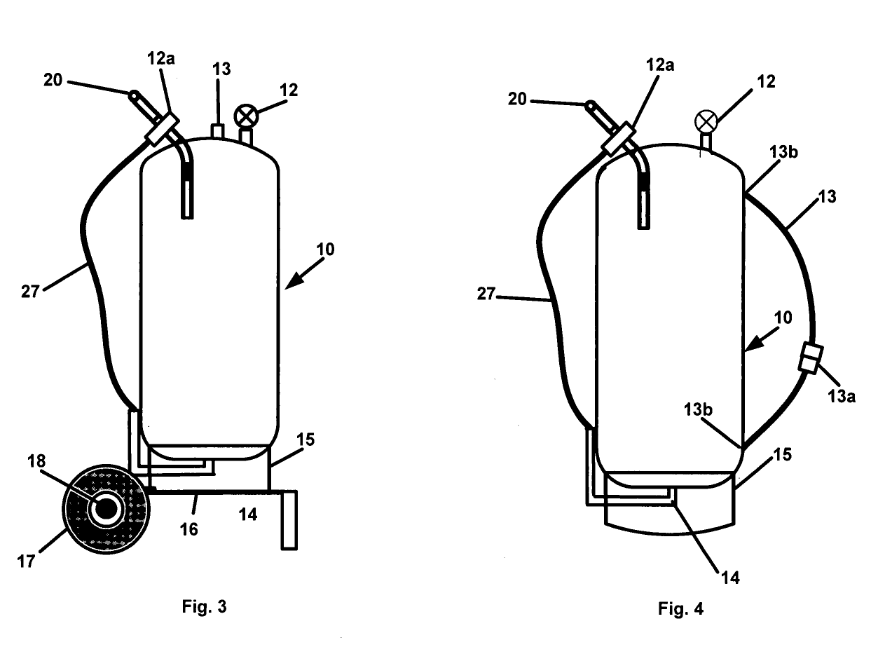

As will be apparent from the detailed description which follows the unit of the invention comprises a versatile portable pressurized lubricant tank dispenser capable of varied utility. For example, the tank may be fixed or removable secured to a wall or to a moveable apparatus or used as a wheel mounted device as illustrated in FIG. 3 or as a back pack apparatus as illustrated in FIG. 4.

The under pressure dispensing force, hereinafter referred to as “air” and the substance dispensed, for convenience hereinafter referred to as “lubrication fluid” or “lubricant”, are separated by a tough flexible liquid gas impermeable bladder or diaphragm. The tank is supplied with a sealed supply of contained pressurized air that needs no replenishment. The lubricant is introduced to and replenished in the tank by conventional means, such as, by the use of a pump. The pump is conveniently connected to the tank preferably by means of a convenient quick connect-disconnect coupling. The tank compartment containing the permanently pre-pressurized air or other pressurized gas and separated from the lubricant containing compartment by a flexible impermeable membrane, exerts the necessary force to dispense the lubricant. The lubricant is dispensed, via a suitable nozzle, such as a conventional trigger operated nozzle, as needed by being pushed out, i.e.; ejected by the pressure exerted by precharged air acting on the lubricant supply contained in the tank, via the flexible impermeable membrane which separates the air from the lubricant. It is not necessary to further pressurize the tank with any additional air or gas or to supplement the self-contained pressurized gas to operate the lubricating unit of the invention. The self-contained air source is isolated from the lubricant compartment and is sealed in isolation in the tank. No additional supply of a gas is required to furnish pressure to dispense the totality of the lubricant.

The dispenser tank of the invention employs an internal flexible membrane or diaphragm, which is impermeably to liquid and gas. The impermeability of the diaphragm is such that the precharged air in its separate compartment and the liquid in its adjoining compartment do not mix even under substantial pressure. This assures accurate meter readings of the quantity of working fluid dispensed. Because air invariably contains moisture and can be absorbed into the working fluid impermeable flexible diaphragm separating of lubricant and pressurized gas feature of the invention is important. In many applications it is in fact critical that water vapor and/or air in the compressed air not mix with and contaminate the lubricant to be dispensed.

The impermeable diaphragm or membrane located internally within the tank comprises a partition sheeting of any of the various know though flexible composition which is inert to the fluids with which it is in contact in the tank. Diaphragm compositions of this kind, are known, and include for example those employed for o-ring seals. One composition that may be suitably employed in an acylonitule-butadiene-elastomer, also referred to as is nitrite rubber (NBR), such as the composition available from the Parker Hannifin Corporation of Lexington, Ky.

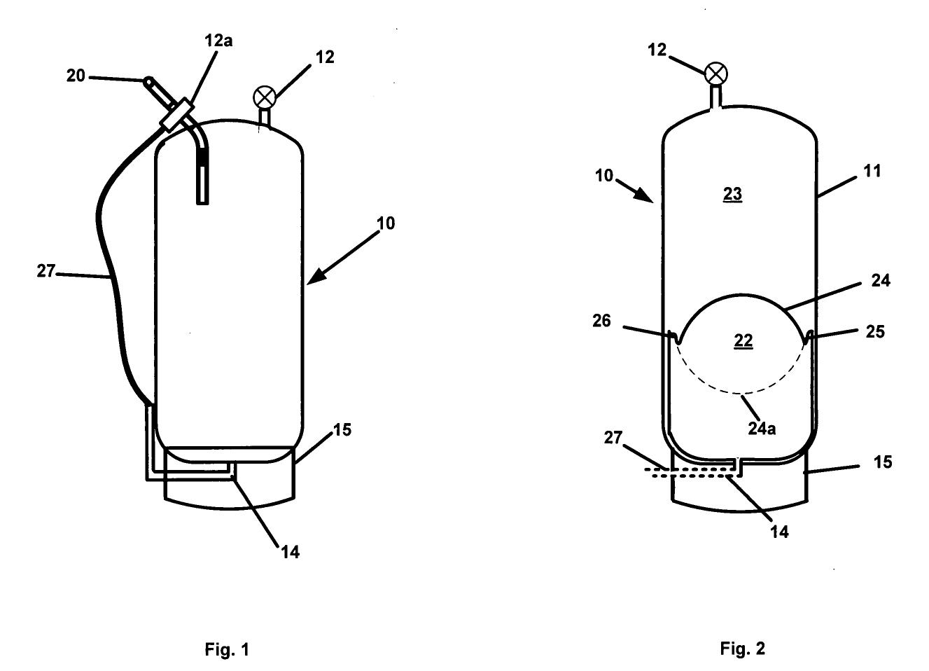

Referring to the embodiment illustrated by FIG. 1 of the drawing, a portable unit 10; comprising a sealed tank 11; equipped with a pressure indicating gauge 12; a gas pressure charging inlet 13; and working fluid dispensing outlet 14, surrounded by a lower protective skirt 15.

While the tank 11 as shown in FIG. 1 when comprising large configurations e.g., containing more than about five gallons of servicing fluid may be mounted on and carried by a conventional dolly as illustrated in FIG. 3, the tank 11 without the dolly arrangement may be conveniently carried as a back-pack as illustrated in Fi 4. It may also be mounted on a wall and placed for example where it can be recharged periodically with lubricant via a subscription service by a disconnectable coupling means which replenishes the lubricant in the tank. The servicing of the tanks at appropriate intervals may take place by a scheduling arrangement or the tank replaced with a refilled unit at the customer's servicing site and the depleted tank refilled with lubricant at the supplier site. In this way, dispensers may be delivered to a user on a schedule or as needed by a servicing distributor. The units may be recharged with servicing fluid by the distributor and returned to the user at a later time or the tank may be replenished on site as needed with a fresh quantity of lubricant.

Referring to FIG. 2 of the drawing the tank unit 11 shown in cross-section illustrates the internal arrangement comprising an upper pressure chamber 23 which contains the pressurizing gas most commonly air and the working fluid chamber 22 which contains lubricating oil, for example as in, separated by the flexible impermeable membrane diaphragm 24 which is securely and completely sealed at the periphery of the diaphragm (shown at 25 and 26) so as to thoroughly seal and isolate the working fluid in chamber 22 from the pressurized air in chamber 23.

In practice it is contemplated that the tank manufacturer supplies the tank 11 with pressurized air in chamber 23. When ready for use lubrication fluid is charged into chamber 22 against the force of the pressurized air contained in compartment 23 which is separated by a bladder or diaphragm 24. The lubricant is charged through port 14 via a suitable coupling connection, such as a conventional quick connect-disconnect coupling. The coupling is then disconnected thus making the tank fully portable.

FIG. 2 illustrates a tank substantially filled with servicing fluid in compartment 22 wherein the flexible membrane 24 is forced upward by the pressure of the lubricant forced into compartment 22 against the pressure of the compressed air in compartment 23. When filling the tank i.e., charging the lubricant into the chamber 22 of the tank 10 through the port 14 the lubricant is introduced by disconnecting the bottom extension of the outlet hose 27 via a conventional, quick disconnect coupling (not shown) at port 14. The filling pump (not shown) is then connected via a quick disconnect coupling at 14 and used to fill (under pressure) chamber 22 with lubricant. The working fluid chamber 22 is filled until a predetermined pressure is obtained as read on a pressure gauge or meter. A metering device 12 or a combination of gauges to monitor the pressure both air and lubricant at any stage of lubricant quantity contained in the tank may be carried on the tank itself, or preferably as shown at 12a on the dispensing hose 27 lubricant chamber. A suitable pressure is typically about 100 psi. In general, with respect to pressure gauges or metering devices, although a gauge 12 is depicted schematically at 12a and 12 respectively in FIGS. 1 and 2 which may be used to monitor the pressure in either chambers 22 or 23, only gauge 12a shown in FIGS. 2 which meters the servicing fluid being dispensed from chamber 22 is required for most uses of the tank assembly of the invention. When the dispensing (chamber 22) is fully charged with working fluid, such as a lubricant oil as reflected on a suitable pressure gauge, the filling charge pump is disconnected from port 14, the outlet hose is reattached to port 14 as shown in FIG. 5. The fluid is then dispensed as needed via outlet port 14 by means of being pushed out by the force of pressure from pressurized air in chamber 23 on the working fluid in chamber 22 via a flexible membrane 24. The quantity of dispensed lubricant is measured on the meter 12a. The Air pressure precharge in chamber 23 acting on the impermeable membrane 24 which separates the air from the fluid provides the ample force to dispense the working fluid. The permanently contained pressure producing gas is contained as a fixture and is supplied by the tank distributor who may supply the tank with or without a charge of lubricant in compartment 22. The air or other gas in compartment 23 is pre-charge and maintained for the life of the tank and no additional quantity of air is required to provide the needed pressure to dispense the lubricant. When the lubricant is substantially discharged the membrane 24 by the force of the gas in compartment 23 is extended to the lower portion as shown by the dotted line 24 as in FIG. 2.

It will be apparent to those skilled in the art that various alternative embodiments may be made to the unit shown without departing from the invention. For example the dispensing tank of the invention may comprise an internal vertically disposed diaphragm and may even include a three-chamber unit not shown comprising two working fluid dispensing chambers pressurized by a third driving pressure filled chamber.

What is claimed is:

1. A portable unit for delivering lubricating fluid under pressure comprising:
an enclosed gas and liquid confining tank; containing at least two isolated chambers;
a first chamber to confine a dispensing pressure fluid in said tank;
a second chamber contiguous to said first chamber to confine a servicing lubricant to be dispensed
said chambers being separated by a gas and liquid impermeable flexible diaphragm;
means consisting essentially of a pressurized gas maintained for the life of the tank confined in said first chamber and operable to exert pressure to dispense lubricant contained in said second chamber via said diaphragm;
inlet means for introducing and for replenishing as needed depleted liquid lubricant into said second chamber; and
outlet means including a nozzled hose for dispensing the servicing lubricant from said second chamber said liquid lubricant being dispensed solely by the pressure exerted via said diaphragm by the air contained in the first chamber.

2. A portable unit according to claim 1 which is removable mounting on a wall to facilitate lubricant replenishment.

3. The portable unit according to claim 1 which is mounted on a wheeled dolly.

4. A portable unit according to claim 1 equipped to be carried as a back-pack.

5. A unit according to claim 1 which inlet means for replenishing and the outlet means dispensing the liquid lubricant is equipped with a quick disconnect coupling for alternatively introducing and dispensing said lubricant.

6. A unit according to claim 1 provided with a detecting gauge on said tank to measure a lubricant contained in said second chamber.

7. A unit according to claim 1 in which the dispensing hose is provided with a metering gauge.

8. The unit according to claim 7, wherein the metering gauge comprises a flow meter to measure the volume of dispensed servicing fluid.

9. A unit according to claim 6 equipped with a gauge to measure the remaining quantity of the contained servicing fluid.

10. A portable system for maintaining and delivering a replenishable supply of lubricant utilizing a lubricating unit with a self-contained pressurized gas for discharging the lubricant comprising:
(a) a portable tank containing a supply of pressurized gas permanently sealed in a first compartment separated from a second compartment by a flexible impermeable membrane;
(b) a replenishable supply of lubricant contained in said second compartment;
(c) means to detect the quantity of lubricant contained in said second compartment;
(d) a nozzle with hose connected to said second compartment for delivering lubricant under pressure through operation of said nozzle; and
(e) means to disconnect said hose from said second compartment to alternatively attach a lubricant resupply conduit to said second compartment and to resupply lubricant as needed to said second compartment.
